(19) United States
(12) Patent Application Publication
(10) Pub. No.: US 2015/0328589 A1
(43) Pub. Date: Nov. 19, 2015

(54) HYDROGEN SEPARATION MEMBRANE MODULE FOR CAPTURING CARBON DIOXIDE

(71) Applicant: KOREA INSTITUTE OF ENERGY RESEARCH, Yuseong-gu Daejeon (KR)

(72) Inventors: Shin-Kun RYI, Daejeon (KR); Jong-Soo PARK, Daejeon (KR); Chun-Boo LEE, Daejeon (KR); Sung-Wook LEE, Daejeon (KR)

(21) Appl. No.: 14/651,953

(22) PCT Filed: Oct. 30, 2013
(86) PCT No.: PCT/KR2013/009721

§ 371 Date: Jun. 12, 2015

(30) Foreign Application Priority Data
Dec. 14, 2012 (KR) 10-2012-0146073

(51) Int. Cl. B01D 69/02; B01D 53/22; C01B 3/50; B01D 71/02

(52) U.S. Cl. CPC B01D 69/02; B01D 71/022; B01D 53/228; C01B 3/508; B01D 2325/20; B01D 2325/30; C01B 2203/06; C01B 2203/86

(57) ABSTRACT

The present invention provides a hydrogen separation membrane module for capturing carbon dioxide. According to the present invention, a module material is used to suppress the reactivity by a carbon source in the separation membrane module during a carbon capture and storage (CCS) process, and is capable of preventing an occurrence of carbon and a decrease in hydrogen partial pressure by a side reaction.

### TECHNICAL FIELD

The present invention relates to a hydrogen separation membrane module for capturing carbon dioxide (CO₂), and more specifically to a hydrogen separation membrane module for capturing carbon dioxide using a module material which may suppress a reaction with a carbon source in the separation membrane module to prevent an occurrence of carbon and a decrease in hydrogen partial pressure due to a side reaction.

### BACKGROUND ART

In an integrated gasification combined cycle (IGCC) process, a carbon capture and storage (CCS) is completed through five steps of coal gasification, desulfurization, water-gas-shift (WGS) reaction, water separation, and carbon dioxide and hydrogen separation using a separation membrane. The WGS reaction is a reaction for preparing hydrogen and carbon dioxide as shown in the following formula, and the carbon dioxide of the hydrogen and carbon dioxide generated in the WGS reaction is captured using a hydrogen separation membrane to produce high-purity hydrogen.

CO+H₂O [symbol] H₂+CO₂

As a technique for separating hydrogen from the hydrogen mixed gases generated in the WGS reaction, a variety methods such as pressure swing adsorption (PSA), deep cooling, chemisorption, and separation using the separation membrane may be used. Among the techniques, the separation process using the separation membrane is known to be the best technique in terms of energy efficiency. Recently, in order to commercialize an extra-large refining portion such as the pre-firing CCS, development of a separation process using the hydrogen separation membrane is under way.

In addition, there has been much research into a module configuration for hydrogen refining using the hydrogen separation membrane, and such research was conducted from the standpoint of securing high-concentration hydrogen that has penetrated the separation membrane. Currently, the market scale relating to hydrogen is 1 trillion Won or more a year around the world, and among the countries, Korea occupies about 5% thereof. The market scale for a high-efficiency hydrogen manufacturing apparatus using the separation membrane has been evaluated as 200 million Won or more a year in Korea. In recent years, as the demand for high-purity hydrogen has become much larger in petrochemical processes including a semiconductor manufacturing process, when applying a hydrogen separation membrane module with maximized performance to the production of high-purity hydrogen and the CCS process, marketability has been evaluated to be very large.

Further, in a separation membrane-applied process for separating carbon dioxide and hydrogen using the separation membrane, hydrogen refining and CO₂ concentration should be satisfied simultaneously, and therefore, it is not possible to obtain a concentration of residual gases at a certain level or more unless the recovery rate of hydrogen is maintained high. That is, when separating hydrogen from the mixed gases, diffusion of material above the separation membrane acts as a dominant factor for the hydrogen removal efficiency of the separation membrane, because the concentration of hydrogen in the residual gases that have not penetrated the separation membrane decreases gradually. Therefore, the configuration of the separation membrane exerts an absolute influence, and the performance of the membrane itself, as well as the performance of the hydrogen separation membrane module are also very important in the carbon dioxide capture using the hydrogen separation membrane.

As a metal material for manufacturing the hydrogen separation membrane module, stainless steel has been generally used. However, representative major metals forming the stainless steel include iron, nickel and chromium, and some material may include silicon, molybdenum, titanium and the like. These metal materials are materials used in a variety of catalytic reactions depending on their purpose, and when being used as a material of the hydrogen separation membrane module, may play a role of a catalyst, and thereby, the catalytic reaction may be proceeded in an unwanted direction.

As described above, when the unwanted catalytic reaction is proceeded, a reverse water-gas-shift (R-WGS) reaction which is a reaction reverse to the WGS reaction may occur as a side reaction. When such the R-WGS reaction occurs, a hydrogen partial pressure is decreased to cause a significant decrease in performance of the module, and thus leading to an occurrence of caulking (carbon generation) due to the side reaction.

### DISCLOSURE

### Technical Problem

In order to solve the above-described problems, it is an object of the present invention to provide a hydrogen separation membrane module for capturing carbon dioxide using a module material which may suppress a reaction with a carbon source in the separation membrane module for capturing carbon dioxide used in a step of separating carbon dioxide and hydrogen using a separation membrane during carbon capture and storage (CCS) to prevent an occurrence of carbon and a decrease in hydrogen partial pressure due to a reverse water-gas-shift (R-WGS) reaction as a side reaction.

### Technical Solution

The present inventors pay sharp attention to the problem in which, when a catalytic reaction is proceeded in the conventional hydrogen separation membrane module for capturing carbon dioxide, the hydrogen partial pressure is decreased and carbon (caulking) is generated due to a reverse water-gas-shift (R-WGS) reaction as the side reaction, and as a result thereof, have conceived an idea wherein gases (carbon dioxide, carbon monoxide, methane, etc.) including carbon may undergo a catalytic reaction which reacts with catalytic metal included in the surface of stainless steel forming a module material inside of the hydrogen separation membrane module as a side reaction.

That is, the present inventors have conceived an idea that suppressing a reaction of a catalyst in the separation membrane module is very important, because, as the most important cause of proceeding the catalytic reaction in the hydrogen separation membrane module for capturing carbon dioxide, stainless steel used as the material of the hydrogen separation membrane module includes a metal material such as iron, nickel, chromium, etc., and these metal materials act as a catalyst that can lead to a variety of catalytic reactions depending on their purpose, such that the gas molecules (carbon dioxide, carbon monoxide, and methane, etc.) including carbon on the surface of a module made of the stainless steel material are adsorbed on the surface of stainless steel forming the module material inside of the hydrogen separation membrane module, and thereby lead to the side reaction by reacting with catalytic metal contained in the stainless steel, and significantly reduce the performance of the hydrogen separation membrane module. Based on this idea, the present inventors find that, when employing a material which does not facilitate the catalytic reaction instead of a material conventionally used in the art, the side reaction is not generated, in particular, that carbon uptake may not be generated in the module, and this completes the present invention.

### Advantageous Effects

According to the present invention, by employing stainless steel including nickel and chromium in a high content as a material of the hydrogen separation membrane module for capturing carbon dioxide, the reverse water-gas-shift (R-WGS) reaction of the side reaction may be suppressed in the hydrogen separation membrane module, and carbon uptake may not be generated in the separation membrane module, such that it is possible to obtain an improvement in durability of the hydrogen separation membrane module and excellent results of capturing carbon dioxide.

### Best Mode

The present invention relates to a hydrogen separation membrane module for capturing carbon dioxide which is used in a step of separating carbon dioxide and hydrogen using a separation membrane during carbon capture and storage (CCS), and in particular, provides a hydrogen separation membrane module for capturing carbon dioxide which uses stainless steel material including nickel and chromium in a high content, so as to prevent an occurrence of the reverse water-gas-shift reaction in the module, and thus prevent a decrease in hydrogen partial pressure without generating the carbon uptake in the separation membrane module.

Stainless steel contains iron (Fe) as a base metal and chromium (Cr) and nickel (Ni) as main raw materials, and various characteristics may be obtained by adding chemical elements other than chromium and nickel. In addition, the stainless steel may be largely classified according to the chemical composition and crystalline structure of metal. Specifically, the stainless steel is classified into an iron-chromium (Fe—Cr) alloy and iron-chromium-nickel (Fe—Cr—Ni) alloy in terms of the chemical composition, and classified into an austenitic stainless steel of an iron-chromium-nickel (Fe—Cr—Ni) alloy, duplex stainless steel, a ferrite stainless steel of an iron-chromium (Fe—Cr) alloy, and a martensite stainless steel. Among such stainless steels, austenitic stainless steel has no magnetism and has excellent corrosion resistance, impact resistance and heat resistance due to a high increased adhesiveness with a surface oxide film, and is thus being used as a material for various types of chemical plants. As a representative steel type, austenitic stainless steel (having 18% of Cr and 8% of Ni) is known in the art.

Representative metal components forming the austenitic stainless steel includes iron, chromium and nickel, and some stainless steel may include molybdenum and titanium in a very small amount. Accordingly, the metal components such as nickel and chromium, etc. contained in the austenitic stainless steel are materials used in a variety of catalytic reactions depending on their purpose, and when they are used as a material of the hydrogen separation membrane module, a structure having a catalytic function is formed on the surface of the hydrogen separation membrane module, and thereby expressing catalytic activity to cause a catalytic reaction. However, austenitic stainless steel containing a nickel and chromium component in a high content has characteristics of improving oxidation resistance and heat resistance due to a high denseness of the crystalline structure of the alloy, as well as exhibits desired properties with little expression of catalytic activity compared to other stainless steels.

Further, if the content of silicon (Si) as a small amount of the chemical composition is high in the austenitic stainless steel, characteristics of improving oxidation resistance at high temperature may be expressed. Therefore, an ultra-thin concentrated layer is formed by silicon dioxide on the surface of the stainless steel and an interface between metals inside thereof, which functions to prevent an external diffusion of metal ions and internal diffusion of oxygen as a protective film, and thereby exhibits desired properties with little expression of catalytic activity compared to other stainless steels.

When a material such as stainless steel is exposed to a gas including carbon such as CO, CO₂, or CH₄ etc., a carbonization phenomenon occurs. Herein, the degree of carbonization is determined by the level of carbon and oxygen in the gas, the temperature, and composition of the stainless steel. Due to the carbonization, the surface of the stainless steel may be deteriorated, because carbide or a carbide connection is formed within the crystalline structure of the stainless steel or the interface between the crystalline structures. Alloy chemical elements for providing the greatest increase in resistance to carbonization are chromium (Cr), nickel (Ni) and silicon (Si) as can be seen from the following Table 1.

TABLE 1

| | | |
|---|---|---|
| | Stainless | |
| | steel | Carbone |
| Content (%) | type | uptake |

| Item | Cr | Ni | Other | (AISI) | (%) |
|---|---|---|---|---|---|
| 1 | 18 | 9 | — | 304 | 2.6 |
| 2 | 18 | 9 | 2.5 Si | 302B | 0.1 |
| 3 | 18 | 10 | Ti | 321 | 1.5 |
| 4 | 18 | 10 | Nb | 347 | 0.2 |
| 4 | 17 | 11 | 2.0 Mo | 316 | 1.0 |
| 5 | 23 | 13 | — | 309S | 0 |
| 6 | 25 | 20 | — | 310S | 0 |
| 7 | 25 | 20 | 2.5 Si | 314 | 0 |
| 8 | 15 | 35 | — | 330 | 0.9 |

Referring to results of carbon uptake shown in Table 1 in a gas having a composition of 34% of H₂, 14% of CO, 12.4% of CH₄, and 39.6% of N₂ under 910° C. after 7,340 hours, it can be seen that various results of carbon uptake by the carbon source under the same condition as for each composition type with reference to the Cr and Ni components which express catalytic activity in austenitic stainless steel are obtained.

According to the results of the carbon uptake, it can be seen that the carbon uptake was never generated only for austenitic stainless steel having a composition within a range of 23 percent by weight (‘wt %’) of Cr and 13 wt % of Ni, and 25 wt % of Cr and 20 wt % of Ni, and austenitic stainless steel having a composition within a range of 25 wt % of Cr, 20 wt % of Ni and 2.5 wt % of Si as another chemical component.

As can be seen from the above description, when using the austenitic stainless steel containing Cr in a range of 20 to 30 wt % and Ni in a range of 12 to 35 wt %, and the austenitic stainless steel containing Si in a range of 1.5 to 3.0 wt % among other chemical components, and preferably, the austenitic stainless steel containing Cr in a range of 22 to 26 wt % and Ni in a range of 12 to 22 wt %, and the austenitic stainless steel containing Si in a range of 1.5 to 3.0 wt % among other chemical components as the material of the hydrogen separation membrane module for capturing carbon dioxide, it can be found that a reaction with the carbon source in the hydrogen separation membrane module may be suppressed, so as to prevent an occurrence of carbon and a decrease in hydrogen partial pressure due to the side reaction, and the present invention is completed.

As the austenitic stainless steel containing nickel and chromium in a high content, which is used as the material of the hydrogen separation membrane module for capturing carbon dioxide in a step of separating carbon dioxide and hydrogen using the separation membrane during the carbon capture and storage (CCS), the stainless steel including Cr in a content of 20 to 30 wt % and Ni in a content of 12 to 35 wt % as a chemical element component other than an iron (Fe) component is suitable, and the stainless steel may include 0.08 wt % or less of carbon (C), 1.50 wt % or less of silicon (Si), 2.0 wt % or less of manganese (Mn), 0.045 wt % or less of phosphorous (P), and 0.03 wt % or less of sulfur (S) as other chemical components. As an example of the austenitic stainless steel containing nickel and chromium in a high content which is suitable as the above-described stainless steel, AISI international standard SS 309 S and SS 310 S are preferably used.

As a material containing silicon (Si) in a relatively high content of the austenitic stainless steel containing nickel and chromium in a high content, which is suitable as the material of the hydrogen separation membrane module for capturing carbon dioxide, there is stainless steel which includes silicon (Si) in a range of 1.50 to 3.0 wt % as another chemical component, while including Cr in a content of 20 to 30 wt % and Ni in a content of 12 to 35 wt % as a chemical element component other than an iron (Fe) component. As an example of the austenitic stainless steel containing nickel, chromium and silicone in a high content which is suitable as the above-described stainless steel, AISI international standard SS 314 is preferably used.

Meanwhile, when using the austenitic stainless steel containing less than 20 wt % of Cr and less than 12 wt % of Ni as the material of the hydrogen separation membrane module for capturing carbon dioxide which is used in the step of separating carbon dioxide and hydrogen using the separation membrane during the carbon capture and storage (CCS), there are problems that carbon monoxide (CO) is produced in a large amount due to increased reactivity and carbon uptake is generated. In addition, austenitic stainless steel which includes chromium (Cr) and nickel (Ni) in a range of exceeding 30 wt % and 35 wt %, respectively among types of steel that can be currently produced and employed as the austenitic stainless steel is not known in the art.

Hereinafter, embodiments will be described to more concretely understand the present invention with reference to examples. However, those skilled in the art will appreciate that such embodiments are provided for illustrative purposes and do not limit subject matters to be protected as disclosed in the detailed description and appended claims.

### EXAMPLE

After, a test module was prepared by selecting the following austenitic stainless steel as a material of manufacturing a hydrogen separation membrane module for capturing carbon dioxide, experimental results of capturing carbon dioxide in the prepared test module were obtained, and then the composition of captured gas was analyzed using the obtained experimental results.

Analysis of Composition of Carbon Dioxide Captured Gas

The composition of the captured gas which is captured under experimental conditions of a temperature of 400° C. and a pressure difference of 20 atm at a feed rate of 2 L/min of feed gas, 60% H₂+40% CO₂, was analyzed.

According to the above analyzed results of the composition of the captured gas, austenitic stainless steel having a content of 26 wt % of Cr and 22 wt % of Ni shows the lowest reactivity such that 0.1% or less of carbon monoxide (CO) is detected, while austenitic stainless steels having a content of 18 wt % of Cr and 9 wt % of Ni, and 17 wt % of Cr and 11 wt % of Ni, respectively, shows a relatively high reactivity and high content of carbon monoxide (CO).

TABLE 2

| | | | | Stainless | | | | |
|---|---|---|---|---|---|---|---|---|
| | Content (%) | | | steel type | Captured gas concentration (%) | | | |
| Item | Cr | Ni | Other | (AISI) | H₂ | CO | CH₄ | CO₂ |
| 1 | 18 | 9 | — | 304 | 10.1 | 10.5 | 2.0 | 77.5 |
| 2 | 17 | 11 | 2.0 Mo | 316 | 16.9 | 2.6 | — | 80.5 |
| 3 | 26 | 22 | — | 310S | 6.1 | 0.1 | — | 93.9 |

As can be seen from the above description, in the module using austenitic stainless steel containing chromium and nickel in a high content within a range of 20 to 30 wt % and 12 to 35 wt %, respectively, as the material of the hydrogen separation membrane module for capturing carbon dioxide, and austenitic stainless steel containing Si in a high content within a range of 1.5 to 3.0 wt % among the above range, a reaction with the carbon source in the hydrogen separation membrane module was suppressed, and thereby preventing an occurrence of carbon uptake, and showing excellent capturing efficiency.

1. A hydrogen separation membrane module for capturing carbon dioxide, comprising:
austenitic stainless steel which contains 20 to 30 wt % of chromium (Cr) and 12 to 35 wt % of nickel (Ni) as a material of the module, so as to suppress a reaction with a carbon source generated on a surface of the hydrogen separation membrane module and prevent carbon uptake.

2. A hydrogen separation membrane module for capturing carbon dioxide, comprising:
austenitic stainless steel which contains 20 to 30 wt % of chromium (Cr), 12 to 35 wt % of nickel (Ni) and 1.5 to 3 wt % of silicon (Si) as a material of the module, so as to suppress a reaction with a carbon source generated on a surface of the hydrogen separation membrane module and prevent carbon uptake.

3. The hydrogen separation membrane module according to claim 1, comprising austenitic stainless steel which contains 22 to 26 wt % of chromium (Cr) and 12 to 22 wt % of nickel (Ni) as a material of the module.

4. The hydrogen separation membrane module according to claim 2, comprising austenitic stainless steel which contains 22 to 26 wt % of chromium (Cr), 12 to 22 wt % of nickel (Ni) and 1.5 to 3 wt % of silicon (Si) as a material of the module.

5. The hydrogen separation membrane module according to claim 1, wherein the austenitic stainless steel is any one of AISI international standard SS309S and SS310S.

6. The hydrogen separation membrane module according to claim 2, wherein the austenitic stainless steel is AISI international standard SS314.
